(19) United States
(12) Patent Application Publication
(10) Pub. No.: US 2013/0104633 A1
(43) Pub. Date: May 2, 2013

(54) SYSTEM FOR DETERMINING AN ANALYTE IN A WATER SAMPLE

(71) Applicants: Dietmar Zangenberg, Duesseldorf (DE); Carsten Schulz, Dormagen (DE)

(72) Inventors: Dietmar Zangenberg, Duesseldorf (DE); Carsten Schulz, Dormagen (DE)

(73) Assignee: HACH LANGE GMBH, BERLIN (DE)

(21) Appl. No.: 13/701,022

(22) PCT Filed: May 31, 2011
(86) PCT No.: PCT/EP11/58993

§ 371 Date: Jan. 11, 2013

(30) Foreign Application Priority Data
Jun. 1, 2010 (EP) 10164589.3

(51) Int. Cl. G01N 1/10

(52) U.S. Cl. CPC G01N 1/10
USPC 73/61.59

(57) ABSTRACT

A system for determining an analyte in a water sample includes at least one stationary sampling site identification transmitter at a sampling site. The at least one stationary sampling site identification transmitter is configured to wirelessly transmit a sampling site identification. A mobile sample container is configured to take a sample at the sampling site. The mobile sample container comprises a transmitter and receiver device. The transmitter and receiver device comprises a memory for the sampling site identification and for a sampling time stamp. A time stamp generator comprises a time stamp transmitter configured to wirelessly transmit the sampling time stamp. A water analysis device comprises a receiver configured to wirelessly receive the sampling site identification and the sampling time stamp from the transmitter and receiver device.

### CROSS REFERENCE TO PRIOR APPLICATIONS

This application is a U.S. National Phase application under 35 U.S.C. §371 of International Application No. PCT/EP2011/058993, filed on May 31, 2011 and which claims benefit to European Patent Application No. 10164589.3, filed on Jun. 1, 2010. The International Application was published in German on Dec. 8, 2011 as WO 2011/151350 A1 under PCT Article 21(2).

### FIELD

The present invention relates to a system for determining an analyte in a water sample.

### BACKGROUND

Automation and simplification of processes are indispensable if a careful and accurate analysis of water samples is to be provided. In many fields of water analysis, such as in water treatment installations, the entire process of water analytics, i.e., sampling, sample processing and measuring, is performed by persons not trained for this purpose. The samples to be analyzed are further often provided only with insufficient information, for example, about the sampling site, date and time. This can in practice result in confusion with regard to samples respectively taken at a certain time so that a correct chronological record cannot be guaranteed. Sample information must further be entered manually into the water analysis device prior to each measuring, which may be the source of further errors and additional delays.

### SUMMARY

An aspect of the present invention is to provide a system for determining an analyte in a water sample that allows for a simpler and a more reliable documentation.

In an embodiment, the present invention provides a system for determining an analyte in a water sample which includes at least one stationary sampling site identification transmitter at a sampling site. The at least one stationary sampling site identification transmitter is configured to wirelessly transmit a sampling site identification. A mobile sample container is configured to take a sample at the sampling site. The mobile sample container comprises a transmitter and receiver device. The transmitter and receiver device comprises a memory for the sampling site identification and for a sampling time stamp. A time stamp generator comprises a time stamp transmitter configured to wirelessly transmit the sampling time stamp. A water analysis device comprises a receiver configured to wirelessly receive the sampling site identification and the sampling time stamp from the transmitter and receiver device.

### BRIEF DESCRIPTION OF THE DRAWINGS

The present invention is described in greater detail below on the basis of embodiments and of the drawings in which:

FIG. 1 shows a schematic illustration of the system for determining an analyte in a water sample according to the present invention.

### DETAILED DESCRIPTION

The system for determining an analyte in a water sample comprises at least one stationary sampling site identification transmitter fixedly installed at a sampling site, for example, at a basin of a waste water treatment installation, and which wirelessly transmits a sampling site identification either permanently or on demand. The system includes a mobile sample container adapted for taking the water sample at the sampling site. The mobile sample container has an associated transmitter and receiver device, which transmitter and receiver device has a memory for the sampling site identification and for a sampling time stamp. The sampling time stamp is generated by a time stamp generator. The time stamp generator is provided with a time stamp transmitter that wirelessly transmits the sampling time stamp. The system further comprises a water analysis device that performs the determination of the analyte in a water sample prepared for measuring. The water analysis device comprises a receiver for the wireless reception of the sampling site identification and the sampling time stamp from the transmitter and receiver device associated with the sample container.

As soon as a user has taken a water sample from at the intended sampling site, e.g., a basin in a water treatment installation, the transmitter and receiver device associated with the sample container wirelessly receives position information about the sampling site, for example, in a situation where the sample container with the associated transmitter and receiver device and the sampling site identification transmitter are within a defined minimum distance from each other. The transmitter and receiver device receives further information via the time stamp generator, i.e., an indication of the date and the time, the so-called time stamp. It is thus provided that all required information about the water sample taken is generated automatically and is recorded in a simple and accurate manner.

The recorded information about the sample is received by the water analysis device as soon as the sample container with the associated transmitter and receiver device is within the range of the receiver of the water analysis device. Every water sample taken can thus be allocated and recorded without error and with an exact time stamp. Such a system also provides for a simple and reliable handling of the analysis process.

In an embodiment of the present invention, the time stamp generator can, for example, be part of a mobile separate hand-held device comprising a receiver for the wireless reception of the sampling site identification. Using the mobile hand-held device, the sampling site identification, together with the generated sampling time stamp, can be transmitted to the transmitter and receiver device associated with the sample container.

In an embodiment of the present invention, the mobile separate hand-held device can, for example, comprise an activation key and a transmission key. When the activation key is actuated, the hand-held device wirelessly requests the sampling site identification from the sampling site identification transmitter and receives the same. When the transmission key is actuated, the sampling site identification is wirelessly transmitted by the hand-held device, together with the generated sampling time stamp. The mobile separate hand-held device may also comprise an electric energy storage supplying the hand-held device with the electric energy necessary for its operation.

Using the mobile separate hand-held device, the sampling site identification is requested and received from the sampling site identification transmitter, fixedly installed at the sampling site, when the optional activation key is actuated. As soon as the hand-held device has received the sampling site identification, i.e., the position, this information is completed with the sampling time stamp, i.e., the present date and time. An acoustic and/or optic acknowledgment provides a confirmation to the user. This process is typically performed after a sample has been taken so that, in a next step, the user can use the optional transmission key to transmit the information to the transmitter and receiver device of the sample container in order to end the recording.

The recorded information of the sample is received by the water analysis device as soon as the sample container with the associated transmitter and receiver device is within the range of the receiver of the water analysis device. Such a system provides for a simple and reliable handling of the analysis process.

In an embodiment of the present invention, the time stamp generator can, for example, be associated with the sampling site identification transmitter. The time stamp generator can alternatively also be associated with the transmitter and receiver device of the sample container. A time stamp generator associated with the sampling site identification transmitter or the transmitter and receiver device of the sample container provides that all information about the water sample taken necessary for a chronological documentation are recorded automatically within the process flow.

In an embodiment of the present invention, the transmitter and receiver device can, for example, be realized as a water-tight label with an integrated RFID chip attached to the sample container. The transmitter and receiver device includes a rewritable memory that stores the position, date and time data. The label is realized such that reusability is provided for at least 100 rinsing cycles in an industrial washer.

In an embodiment of the present invention, the transmitter and receiver device can, for example, be integrated in a magnetic agitator element. The magnetic agitator element remains in the sample container during the process so that the sampling can be recorded by the user. Such a magnetic agitator element also provides a secondary function, i.e. the homogenization of the sample by means of a magnetically driven agitator plate.

In an embodiment of the present invention, the transmitter and receiver device can, for example, be integrated in the sample container body. If the sample container is injection molded, the transmitter and receiver device can, for example, be overmolded or inserted during injection when the container is produced.

In an embodiment of the present invention, the sampling site identification transmitter and the transmitter and receiver device associated with the sample container can, for example, be passive transponders. The energy needed for transmission and reception is supplied by the mobile separate hand-held device or the receiver at the water analysis device so that the information can be received. Passive transponders are cost-effective since energy storage and additional maintenance costs can be omitted.

In an embodiment of the present invention, the water analysis device can, for example, comprise a call key that triggers a command when actuated, so that the receiver at the water analysis device wirelessly requests and receives the sampling site identification and sampling time stamp from the transmitter and receiver device associated with the sample container.

In an embodiment of the present invention, the water analysis device can request the sampling site identification and the sampling time stamp from the transmitter and receiver device in a permanent and wireless manner. As soon as the sample container with the associated transmitter and receiver device is within a defined proximity to the receiver of the water analysis device, the information can be read out.

In an embodiment of the present invention, the water analysis device can, for example, include a sampling time stamp verification device with which the sample age of the water sample can be verified. The recorded information of the water sample taken are processed and evaluated by a data processing program stored in a computer integrated in the water analysis device. In this manner, the user can obtain information about a property of the water sample. This may be, for example, the specific age of the water sample. Further possible applications known to an expert using such a data processing program are also conceivable, such as an alarm in the event of identical time stamps of a plurality of water samples.

In an embodiment of the present invention, the memory of the transmitter and receiver device associated with the sample container can, for example, be deleted by a delete command from the mobile separate hand-held device. The memory of the transmitter and receiver device associated with the sample container can alternatively be deleted by a delete command from the water analysis device. Deleting the memory is effected, for example, by overwriting the memory with the new sampling time stamp generated by the time stamp generator.

An embodiment of the present invention will be described hereinafter with reference to the drawing.

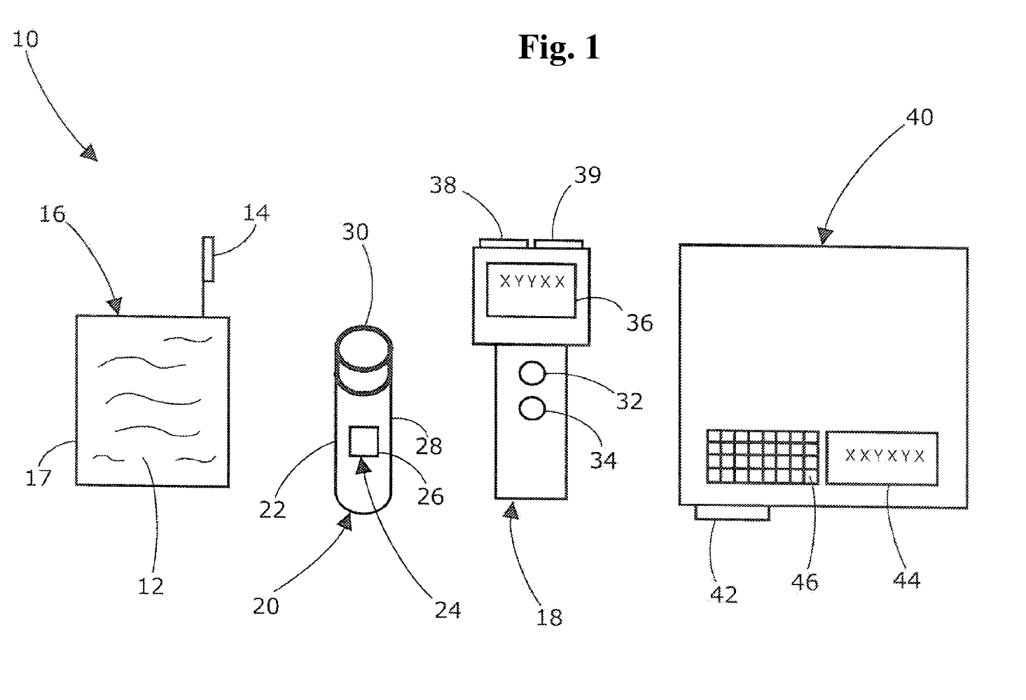

FIG. 1 illustrates a system 10 for determining an analyte in a water sample 12. The system 10 comprises at least one sampling site identification transmitter 14 which is provided at one or a plurality of sampling sites 16, respectively, and which wirelessly transmits a respective individual sampling site identification upon a request from a mobile separate hand-held device 18.

The system 10 includes a sample container 20 adapted for taking a water sample 12. Attached on the outer sample container wall 22 is a transmitter and receiver device 24 in the form of a water-tight RFID label 26, the device being associated with the sample container 20. The transmitter and receiver device 24 includes a rewritable memory for storing position, date and time data. The transmitter and receiver device 24 can alternatively be integrated in the sample container body 28, e.g., in the sample container wall 22, or in the closure cap 30 of the sample container 20.

The mobile separate hand-held device 18 comprises an activation key 32 by means of which a user (not illustrated) requests the sampling site identification from the sampling site identification transmitter 14 as soon as a water sample 12 has been taken from a sampling site 16, such as a basin 17 in a water treatment installation. Upon actuation of the activation key 32, a tie stamp transmitter 38 of the mobile separate hand-held device 18 transmits induction energy to the sampling site identification transmitter 14, which may be realized as a passive transponder, for example, so that the same transmits the sampling site identification to a receiver 39 of the hand-held device 18. By actuating the activation key 32, a sampling time stamp, i.e., an indication of the date and the time, is generated at the same time. All three items of information are displayed to the user on a display 36. The mobile separate hand-held device 18 comprises a transmission key 34, by which the user transmits the position, date and time data to the transmitter and receiver device 24 associated with the sample container 20, so that the position, date and time data is stored in the memory. If previous position, date and time date exist in the memory, the same is overwritten by the new information transmitted by the hand-held device 18.

The system 10 includes a water analysis device 40 comprising a receiver 42 for the wireless reception of the sampling site identification and the sampling time stamp, recorded in the transmitter and receiver device 24. The receiver 42 permanently transmits induction energy so that, as soon as the sample container 20 with the associated transmitter and receiver device 24 is within the range of the receiver 42 of the water analysis device 40, the information stored about the water sample 12 is transmitted and displayed on a display 44 of the water analysis device 40. Using a keyboard 46, the user can enter further inputs at the water analysis device 40 regarding the water sample 12. As an alternative, the display 44 can be configured as a touch-display so that the user can enter all possible inputs via this touch-display.

The present invention is not limited to embodiments described herein; reference should be had to the appended claims.

What is claimed is:

1-14. (canceled)

15. A system for determining an analyte in a water sample, the system comprising:
at least one stationary sampling site identification transmitter at a sampling site, the at least one stationary sampling site identification transmitter being configured to wirelessly transmit a sampling site identification;
a mobile sample container configured to take a sample at the sampling site, the mobile sample container comprising a transmitter and receiver device, the transmitter and receiver device comprising a memory for the sampling site identification and for a sampling time stamp;
a time stamp generator comprising a time stamp transmitter configured to wirelessly transmit the sampling time stamp; and
a water analysis device comprising a receiver configured to wirelessly receive the sampling site identification and the sampling time stamp from the transmitter and receiver device.

16. The system as recited in claim 15, further comprising a separate mobile hand-held device comprising the time stamp generator and a receiver configured to receive the sampling site identification from the at least one stationary sampling site identification transmitter, wherein the sampling site identification is transmittable together with the sampling time stamp from the time stamp transmitter.

17. The system as recited in claim 16, wherein the separate mobile hand-held device further comprises an activation key and a transmission key, wherein the separate mobile hand-held device is configured to wirelessly request and receive the sampling site identification upon an activation of the activation key and to wirelessly transmit the sampling site identification and the sampling time stamp upon an activation of the transmission key.

18. The system as recited in claim 16, wherein the memory of the transmitter and receiver device is deletable via issuance of a delete command from the separate mobile hand-held device.

19. The system as recited in claim 15, wherein the time stamp generator is associated with the at least one sampling site identification transmitter at the sampling site.

20. The system as recited in claim 15, wherein the time stamp generator is associated with the transmitter and receiver device at the mobile sample container.

21. The system as recited in claim 15, wherein the transmitter and receiver device is provided as a water-tight label.

22. The system as recited in claim 15, wherein the mobile sample container further comprises a magnetic agitator element, and the transmitter and receiver device is integrated in the magnetic agitator element.

23. The system (10) as recited in claim 15, wherein the mobile sample container further comprises a body, and the transmitter and receiver device is integrated in the body.

24. The system as recited in claim 15, wherein the at least one stationary sampling site identification transmitter and the transmitter and receiver device associated with the mobile sample container are each provided as a passive transponder.

25. The system as recited in claim 15, wherein the water analysis device further comprises a call key, the water analysis device being configured to wirelessly request and receive the sampling site identification and the sampling time stamp associated with the mobile sample container upon an actuation of the call key.

26. The system as recited in claim 15, wherein the water analysis device is configured to permanently wirelessly request the sampling site identification and the sampling time stamp from the transmitter and receiver device.

27. The system as recited in claim 15, wherein the water analysis device further comprises a sampling time stamp verification device configured to verify a sample age of the water sample.

28. The system as recited in claim 15, wherein the memory of the transmitter and receiver device is deletable via issuance of a delete command from the water analysis device.
